(19) United States
(12) Patent Application Publication
(10) Pub. No.: US 2005/0229423 A1
(43) Pub. Date: Oct. 20, 2005

(54) Nozzle having thermal-capacitance element

(75) Inventor: Michael Wai Ho Keong, Hong Kong (HK)

Correspondence Address: ALIX YALE & RISTAS LLP, 750 MAIN STREET, SUITE 1400, HARTFORD, CT, 06103, US

(73) Assignee: Kenford Industrial Company Ltd.

(21) Appl. No.: 10/824,250

(22) Filed: Apr. 14, 2004

(51) Int. Cl. F26B 13/10; F26B 21/00

(52) U.S. Cl. 34/96; 34/524

(57) ABSTRACT

A nozzle has an air outlet aperture across which there is situated at least one thermal-capacitance element that is not connected electrically to any power source. The element absorbs thermal energy from a flow of heated air passing over it and provides smooth heat transitions in the exhausted air when a hairdryer that incorporate the nozzle is first activated and when speed and/or temperature controls are manipulated during use.

### BACKGROUND OF THE INVENTION

The present invention relates to nozzles as might be employed on hot air-blowing devices such as hairdryers. More particularly, although not exclusively, the invention relates to a nozzle attachment or integral nozzle for a hand-held hairdryer in which there is situated one or more thermal-capacitance elements over which hot air flows. Such elements will absorb thermal energy from the heated air flowing thereover and provide a heat change-moderating effect to the expelled air during use of the hairdryer.

Known hand-held hairdryers comprise a motor-driven blower that causes air to flow over/through a heating coil. The heated air is exhausted through a nozzle to dry and/or style a user's hair. When the hairdryer is first activated, a hot blast of air can impinge upon the user, who might be unprepared for such a hot instantaneous air blast.

Furthermore, the temperature of the exhausting air stream can change rapidly, particularly when the user makes adjustments to the blower speed and/or heating coil temperature by manipulating controls on the hairdryer during use.

### OBJECT OF THE INVENTION

It is the object of the present invention to overcome or substantially ameliorate at least one of the above disadvantages and/or more generally to provide an improved nozzle.

### DISCLOSURE OF THE INVENTION

There is disclosed herein a nozzle comprising an air outlet aperture across which there is situated at least one thermal-capacitance element to moderate changes in temperature of air exhausted through the nozzle.

Preferably the element has opposed ends and the outlet aperture has slots therein into each of which a respective said opposed ends received.

Preferably, the nozzle further comprises a pair of said elements in parallel spaced-apart interrelationship.

Preferably element(s) is/are formed of a material selected from the group consisting of ceramic, metal and glass.

The nozzle might be formed integrally with a hairdryer body, or formed as an attachment for a hairdryer body. The nozzle might have comb teeth extending from the outlet aperture.

### BRIEF DESCRIPTION OF THE DRAWINGS

A preferred form of the present invention will now be described by way of example with reference to the accompanying drawings, wherein:

FIG. 1 is a schematic perspective illustration of a hairdryer nozzle,

FIG. 2 is a schematic perspective illustration of a hairdryer having a nozzle formed integrally therewith,

FIG. 3 is a schematic perspective illustration of another hairdryer nozzle, and

FIG. 4 is a schematic perspective illustration of a hairdryer having a nozzle like that of FIG. 3 formed integrally therewith.

### DESCRIPTION OF THE PREFERRED EMBODIMENTS

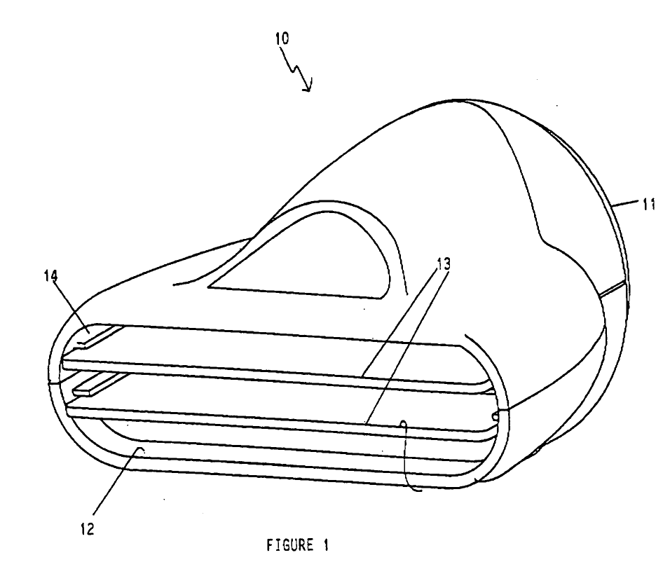

In FIG. 1 of the accompanying drawings there is depicted schematically a hairdryer nozzle 10 having a flange 11 by which it can be engaged with a hairdryer so that heated air passes through the nozzle and is exhausted through an aperture 12. The nozzle 10 might be formed of moulded plastics material in two halves joined along a seam by snap-engagement, screws, plastics welding or adhesive for example. Extending across the aperture 12 is a pair of elements 13 which might be made of ceramic, glass, metal or any other durable material that has a desirable thermal capacitance and can absorb thermal energy from a flow of air, retain the thermal energy and re-radiate or conduct the stored thermal energy back to the flow of air. The elements 13 would not be connected electrically with a power source for the purpose of heating the elements, but might be electrically grounded.

Inside the aperture 12 there are slots 14 into which the ends of the respective elements 13 are received.

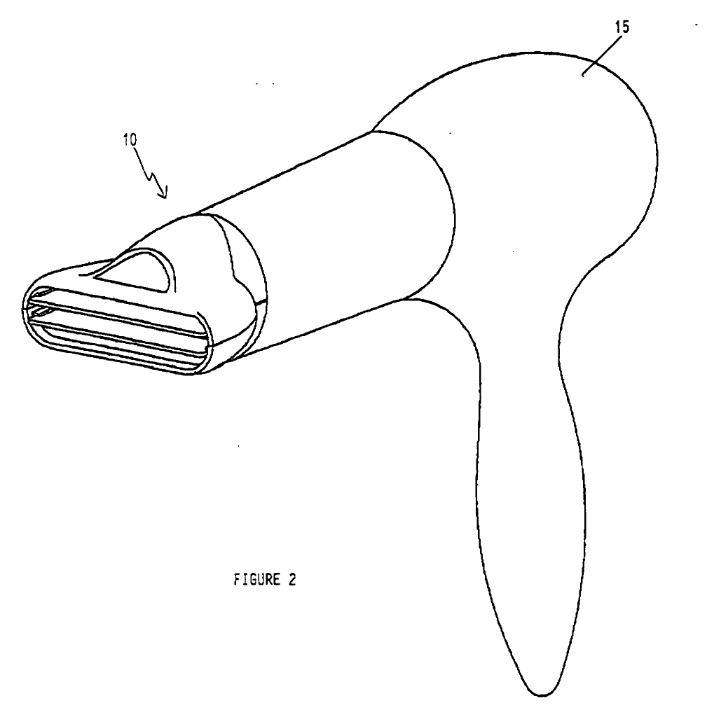

FIG. 2 shows that the nozzle 10 might be attached to or formed integrally with a hairdryer body 15.

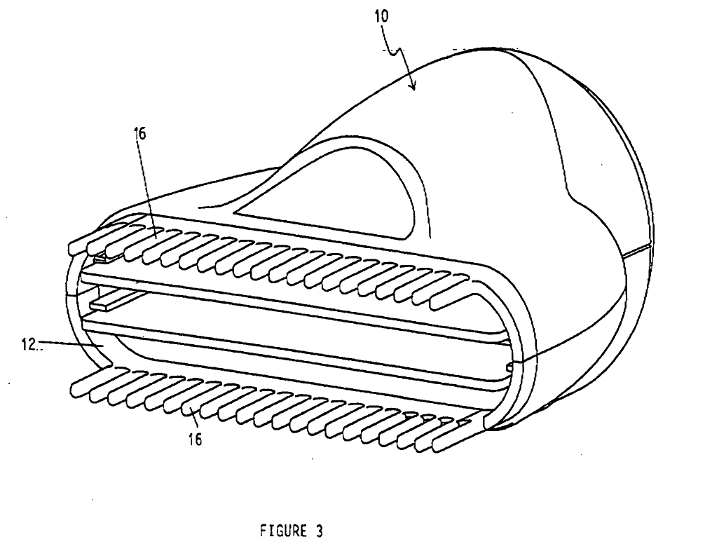

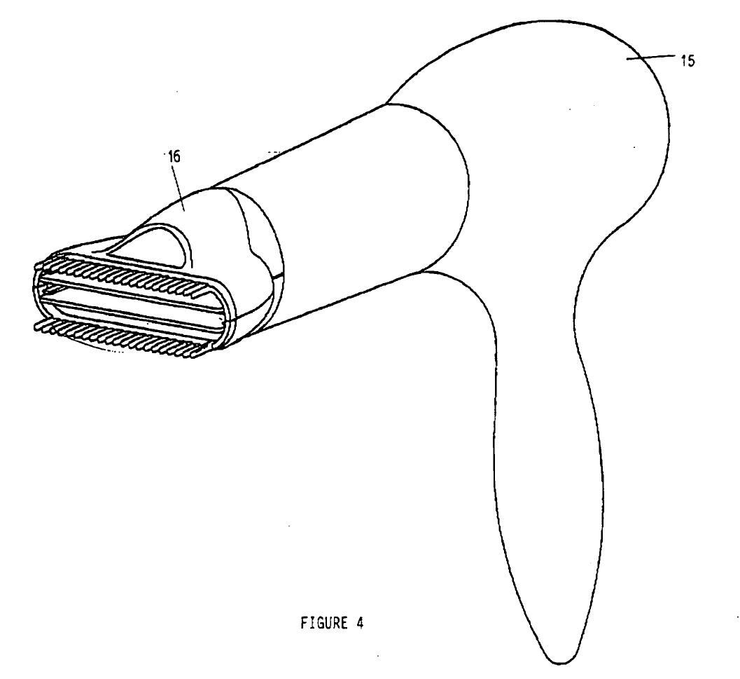

A similar nozzle 10 is shown in FIG. 3 but includes a plurality of comb teeth 16 extending from the aperture 12 and between which strands of hair can pass in use. FIG. 4 shows the nozzle 16 attached to or formed integrally with a hairdryer body 15.

It should be appreciated that modifications and alterations obvious to those skilled in the art are not to be considered as beyond the scope of the present invention. For example, instead of providing elements in the form of flat louvres an depicted, the elements might be rod-like, mesh-like, or in other forms suitable for absorbing and relinquish thermal energy to the flow of air through the nozzle. Furthermore, the nozzle might be configured as a diffuser or be adapted to receive diffusers of various shapes.

1. A nozzle comprising an air outlet aperture across which there is situated at least one electrically isolated thermal-capacitance element configured to moderate air temperature of air exhausted through the nozzle by absorption, retention and re-radiation of thermal energy contained in the air exhausted through the nozzle.

2. The nozzle of claim 1 wherein the element has opposed ends and the outlet aperture has slots therein into each of which a respective said opposed end is received.

3. The nozzle of claim 1 comprising a pair of said elements in parallel spaced-apart interrelationship.

4. The nozzle of claim 1 wherein the element is made of a material selected from the group consisting of ceramic, metal and glass.

5. The nozzle of claim 1 being formed integrally with a hairdryer body.

6. The nozzle of claim 1 being formed as an attachment for a hairdryer body.

7. The nozzle of claim 5 having comb teeth extending from the outlet aperture.

8. The nozzle of claim 6 having comb teeth extending from the outlet aperture.

9. A nozzle comprising an air outlet aperture across which there is situated at least one electrically isolated thermal-capacitance element configured to moderate air temperature of air exhausted through the nozzle by absorption, retention and re-radiation of thermal energy contained in the air exhausted through the nozzle, said nozzle defining a central axis through said outlet aperture and comb teeth projecting from said nozzle in a generally parallel orientation to said central axis.

10. The nozzle of claim 1 comprising a pair of said elements disposed in generally parallel relationship to said central axis.

11. The nozzle of claim 9 being formed integrally with a hair body dryer.

12. The nozzle of claim 9 being formed as an attachment for a hair dryer body.
